(19) United States
(12) Patent Application Publication
(10) Pub. No.: US 2020/0258666 A1
(43) Pub. Date: Aug. 13, 2020

(54) HIGH FREQUENCY POWER INDUCTOR MATERIAL

(71) Applicant: 3M INNOVATIVE PROPERTIES COMPANY, St. Paul, MN (US)

(72) Inventors: Xiaoming Kou, Woodbury, MN (US); Steven D. Theiss, Woodbury, MN (US); Charles L. Bruzzone, Woodbury, MN (US); Michael S. Graff, Woodbury, MN (US); Benjamin P. Mize, Austin, TX (US)

(21) Appl. No.: 16/755,641

(22) PCT Filed: Oct. 11, 2018
(86) PCT No.: PCT/IB2018/057890

§ 371 Date: Apr. 13, 2020

Related U.S. Application Data
(60) Provisional application No. 62/577,871, filed on Oct. 27, 2017.

(51) Int. Cl. H01F 1/153

(52) U.S. Cl. CPC H01F 1/153

(57) ABSTRACT

High frequency power inductor material having first and second opposed major surfaces, comprising a thermosetting binder and a plurality of multilayered flakes dispersed in the high temperature binder, the multilayered flakes comprising at least two layer pairs, wherein each layer pair comprises a ferromagnetic layer and a dielectric electrical isolation layer so that the ferromagnetic layers are electrically isolated from each other by dielectric layers, and wherein the multilayered flakes are substantially aligned parallel to the first and second major surfaces such that they do not provide an electrically continuous path over a range of greater than 0.5 mm. Exemplary high frequency power inductor materials described herein are useful, for example, as a power inductor in Point of Load converters, low profile inductors for inductive—capacitive (LC) filters (e.g., for global system for mobile communication (GSM) pulse noise suppression in cellular phone speakers), or other applications wherein compact, inductive elements are required on a circuit board.

### CROSS REFERENCE TO RELATED APPLICATION

This application claims the benefit of U.S. Provisional Patent Application No. 62/577871, filed Oct. 27, 2017, the disclosure of which is incorporated by reference herein in its entirety.

### BACKGROUND

In electronics products, point of load (POL) converters have been widely used to power integrated circuits (ICs). The close proximity of POLs to ICs is important for performance and efficiency. For example, a battery in a smartphone provides a direct current (DC) voltage of about 4 volts (V), while a smartphone central processing unit (CPU) requires about 1 volt of direct current. Therefore, a POL converter is necessary to step down the voltage, and it is positioned near the CPU to eliminate long wiring. Long wiring is undesirable as it tends to increase electromagnetic interference issues, contribute undesirable stray inductance and capacitance, and complicate the layout of the circuit board. Uses of POL converters include voltage regulation (VR) in providing power to a processer.

Miniaturization is a continuing demand in electronics, especially in computing devices such as laptops, smartphones, and tablets. It leads to lighter and smaller products with more functionality and larger battery, thus a compact POL with high energy density is highly desired. Components in a POL converter include a power management IC chip, power inductor, and capacitor. Among those, the inductor is typically most bulky and becomes a bottle neck in miniaturization. In general, two strategies are available to reduce the inductor footprint. One is to increase inductor working frequency (i.e., the switching frequency of semiconductor devices in power management IC chips). The performance of an inductor in a circuit depends on its impedance, which is proportional to the product of working frequency and inductance. For a certain required impedance, the higher the frequency, the lower the needed inductance, thus, a smaller inductor can be used. A second approach to reduce the inductor footprint is to embed an inductor into a printed circuit board (PCB), and thereby reduce the footprint on the surface of the board.

Minimizing inductor footprint is typically not the only benefit from embedding the inductor and increasing switching frequency. It may also result in reduced capacitor footprint by reducing the need for decoupling capacitance. Moreover, higher switching frequency tends to decrease energy consumption, when, for example, GaN or SiC transistors are used. The energy saving is achieved through better dynamic voltage and frequency scaling, which means the supply voltage will change more dynamically according to the processor workload.

There are two requirements for increasing the working frequency of an inductor. First is the availability of high frequency semiconductor switching devices at the desired power level. Second, magnetic materials suitable for use as high frequency inductors. In recent years, the emergence of high speed and high power SiC and GaN semiconductor devices satisfies the first condition for increasing working frequency. The second condition on high frequency magnetic material, however, has yet to be met.

Power ferrites are an important category of soft magnetic materials, (e.g. nickel zinc ferrites) and are widely adopted in the MHz frequency range. In integration with electronic devices, however, there are issues with their use, such as sensitivity to stress, relatively low saturation magnetic induction, frangibility, and property deterioration under relatively high bias field or relatively high induction swing.

Amorphous or nanocrystalline ribbons may also be used, but they tend to generate too much loss (i.e., heat) as the frequency is increased into the MHz range. This is due to the impracticability of very thin ribbons (they typically exceed about 18 micrometers in thickness) coupled with their low resistivity (typically <500 microΩ-cm), both of which promote high eddy current loss. Although studies (see, e.g., F. Fiorillo et. al., “Magnetic properties of soft ferrites and amorphous ribbons up to radiofrequencies,” J. Magn. Mater., Vol. 322, 2010, pp. 1497-1504; and M. Yagi et. al., “Very low loss ultrathin Co-based amorphous ribbon cores,” J. Appl. Phys., Vol. 64, 1988, pp. 6050-6052) have demonstrated moderate core loss reduction with thinner ribbons. The thinning processes (e.g., melt-spinning in vacuum, chemical etching, and cold rolling) are expensive and difficult to be implemented in mass production.

Another important type of candidate for high frequency application is magnetic metal powders, especially flake shaped powders. Even 0.5 micrometer thin metal flakes tend to generate too much loss at MHz range due to eddy currents and their low ferromagnetic resonance frequency, especially when operated above 5 MHz.

Magnetic thin films made by physical vapor deposition (PVD) or electrochemical deposition have been demonstrated with attractive magnetic properties up to GHz frequency range. Due to stress during growth, however, it is very difficult to achieve a thickness of 10 s or 100 s of micrometers, as required in practice. Another challenge exists in magnetic thin films. During a DC-DC converter operation, there is a DC magnetic bias field acting on the magnetic core, so a slow saturation under bias field in the core material is preferred. NiFe alloy-based magnetic thin films often have fast saturation due to high permeability. It is typically necessary to introduce additional anisotropy into the films to balance permeability and saturation speed. Growing or annealing the films under a magnetic field, or adding other elements into the films can slow down the saturation. If the permeability in the film plane becomes anisotropic, however, the inductor design will become more difficult and complicated.

### SUMMARY

In one aspect, the present disclosure describes a high frequency (i.e., 5 MHz to 150 MHz) power inductor material having first and second opposed major surfaces, comprising:

a high temperature (i.e., capable of withstanding exposure to temperatures of at least 150° C. for at least two minutes and at least 250° C. for at least one minute) binder; and

a plurality of multilayered flakes dispersed in the high temperature binder, the multilayered flakes comprising at least two (in some embodiments, at least 5, 10, 15, 20, 25, 30, 35, 40, 45, 50, 60, 70, 75, 80, 85, 90, 95, or even at least 100; in some embodiments, in a range from 2 to 100, 5 to 50, or even 20 to 40) layer pairs, wherein each layer pair comprises a ferromagnetic layer and a dielectric electrical isolation layer so that the ferromagnetic layers are electrically isolated from each other by dielectric layers, and wherein the multilayered flakes are substantially aligned (i.e., with a full width half maximum (FWHM) of flake angle distribution relative to the film plane of less than 20°) parallel to the first and second major surfaces, such that they do not provide an electrically continuous path (i.e., the electrical resistivity is greater than 1 Ω-cm) over a range of greater than 0.5 mm. For the purposes of this disclosure, a dielectric is a material wherein the lowest conduction band is at an energy level at least seven times k_{B}T higher than the Fermi level, where k_{B} is Boltzmann's constant (i.e., 1.38×10⁻²³ m² kg/(s²K)) and where T is the maximum intended use temperature for the power inductor material. The population of the conduction band is determined by the Fermi Function, F(E)=1/e^{(E-E}^{_{F}}^{)/k}^{_{B}}^{T}+1 , and under the stipulated condition that no more than 10⁻³ of the electrons in the valence band will be promoted into the conduction band. Further, E is the energy level for the lowest conduction band, and E_{F} is the Fermi level. The quantity (E-E_{F}) is known as the “band gap”. Most dielectrics have band gaps on the order of eV. Charles Kittel, Introduction to Solid State Physics, 6th Ed., New York, John Wiley, 1986, p. 185, shows that semiconductor dielectric materials may have band gaps as low as that of InSb at 0.17 eV, or about 6.5 times k_{B}T at room temperature. For example, SiO as a dielectric has a band gap of about 2 eV (see, for example, Hairen Tan et al., “Wide Bandgap p-type Nanocrystalline Silicon Oxide as Window Layer for High Performance Thin-film Silicon Multi-Junction Solar Cells,” Solar Energy Materials and Solar Cells, Vol. 132, pp. 597-605, January 2015). In addition to SiO, other suitable materials as dielectrics include MgF₂, Si, Al₂O₃, and SiO₂.

Exemplary high frequency power inductor material described herein are useful, for example, as power inductors in Point of Load (POL) converters, low profile inductors for inductive-capacitive (LC) filters (e.g., for global system mobile communication (GSM) pulse noise suppression in cellular phone speakers), or other applications wherein compact, inductive elements are required on a circuit board.

Advantages of embodiments of high frequency power inductor materials described herein include the capability to achieve a thickness of up to 100 s of micrometers, with low core loss density (e.g., less than 10,000 kW/m³ at 20 MHz and maximum magnetic induction of 10 mT, and less than 21,000 kW/m³ at 20 MHz and maximum magnetic induction of 15 mT), high saturation magnetic induction (e.g., greater than 0.25 T), relative permeability (e.g., greater than 20), and soft saturation (e.g., saturation field higher than 20 Oe) in the MHz range.

These attributes can enable DC-DC converters working at higher frequencies and can facilitate more efficient circuit board real estate use via a smaller inductor footprint, where inductors may even be embedded as a layer within the circuit board itself When the inductors are embedded in the board, stray reactance associated with discrete components on the board can be avoided. This reduces the need for decoupling capacitors, thus further decreasing the consumption of board real estate. Another advantage is embedding the inductors into the circuit board, and reducing the component count on the circuit board (e.g., decoupling capacitors) which also reduces the amount of electrical noise and electromagnetic interference (EMI) generated by the POL power converters. Enabling higher working frequency also helps improve battery life through fine dynamic voltage and frequency scaling.

### BRIEF DESCRIPTION OF THE DRAWINGS

FIG. 1 is schematic of an exemplary high frequency power inductor material described herein.

FIG. 2 is schematic of another exemplary high frequency power inductor material described herein.

FIG. 3 shows the frequency dependence of permeability in Example 1.

FIG. 4 shows the frequency dependence of permeability in Example 2.

### DETAILED DESCRIPTION

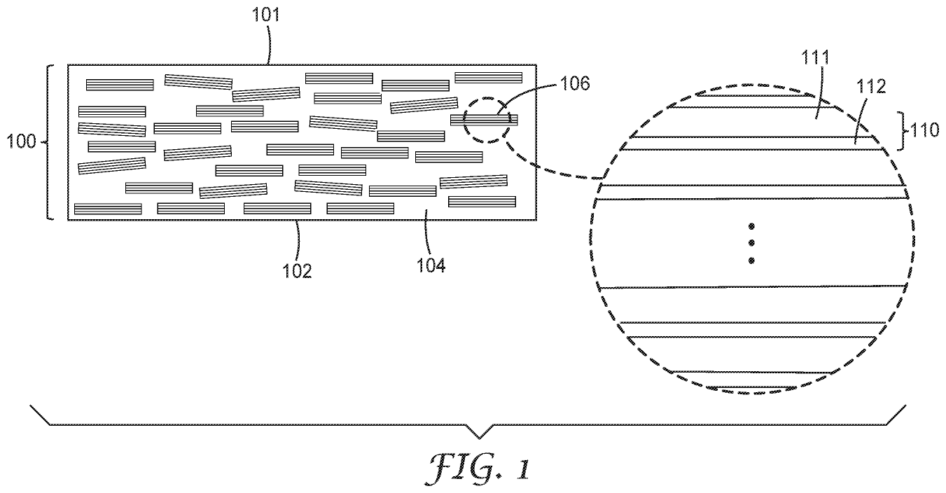

Referring to FIG. 1, high frequency power inductor material 100 has first and second opposed major surfaces 101, 102, high temperature binder 104, and plurality of multilayered flakes 106 dispersed in high temperature binder 104. Multilayered flakes 106 comprise at least two layer pairs 110. Each pair 110 comprises ferromagnetic material layer 111 and adjacent thereto electrically insulating dielectric layer 112 (comprised of electrically insulating material). Multilayered flakes 106 are substantially aligned parallel to first and second major surfaces 101, 102 such that they do not provide an electrically continuous path over a range of greater than 0.5 mm (i.e., multilayered flakes 106 are electrically isolated from each other). For example, the sheet resistance between two vias through the inductor material layer for some embodiments is greater than 10 Ω/square, while for others it may be greater than 1 kΩ/square, and yet for some it may be greater than 1 MΩ/square.

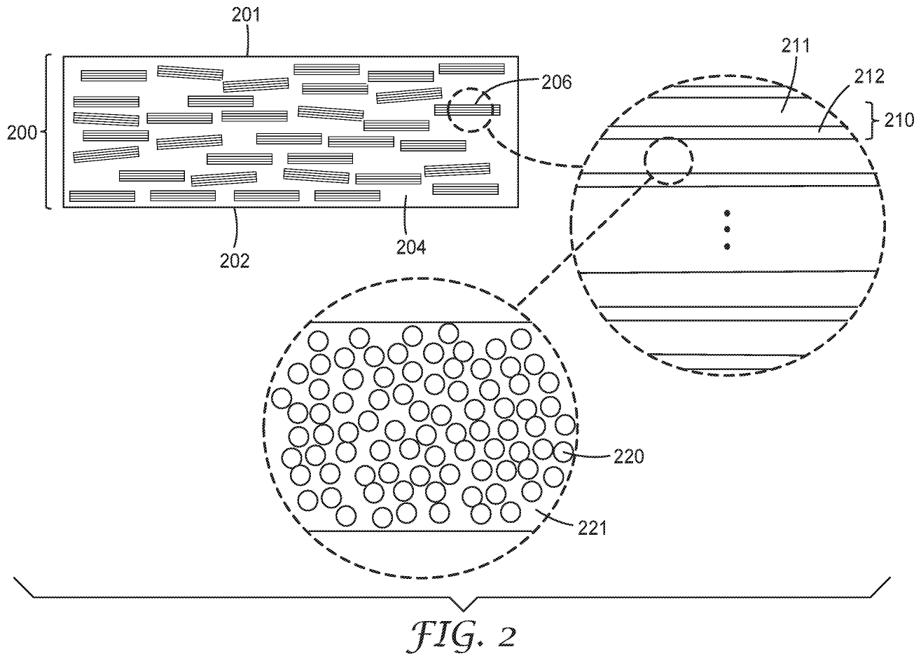

Referring to FIG. 2, high frequency power inductor material 200 has first and second opposed major surfaces 201, 202, high temperature binder 204, and plurality of multilayered flakes 206 dispersed in high temperature binder 204. Multilayered flakes 206 comprise at least two layer pairs 210. Each pair 210 comprises ferromagnetic material layer 211 and adjacent thereto electrically insulating layer 212 (of electrically insulating material). Ferromagnetic material layer 211 comprises granules 220 of ferromagnetic material dispersed in electrically insulating material 221. Multilayered flakes 206 are electrically isolated from each other. Multilayered flakes 206 are substantially aligned parallel to first and second major surfaces 201, 202 such that they do not provide an electrically continuous path over a range of greater than 0.5 mm.

Exemplary electrically insulating materials comprise, on a theoretical basis, at least one of a nitride (e.g., Si₃N₄,), fluoride (e.g., MgF₂), or oxide (e.g., Al₂O₃, HfO₂, SiO, SiO₂, Y₂O₃, ZnO, B₂O₃, and ZrO₂). Sources of electrically insulating materials include those available from Zhongnuo Advanced Material, Beijing, China; EM Industries, Hawthorn, N.Y.; Materion, Milwaukee, Wis.; and RD Mathis, Long Beach, Calif. Other exemplary electrically insulating materials include high temperature (i.e., with a glass transition temperature, T_{g}, exceeding 250° C. and decomposition temperatures exceeding 350° C.) polymeric materials (e.g., polyimides).

In some embodiments, the ferromagnetic material comprises at least one of Co, Fe, or Ni. In some embodiments, the ferromagnetic material comprises at least two of Co, Fe, or Ni (e.g., soft magnetic alloys of FeCo, NiFe, or FeCoNi). In some embodiments, the ferromagnetic material further comprises at least one of Mo, Cr, Cu, V, Si, or Al as additional alloying elements (e.g., soft magnetic alloys of FeSiAl (also commonly referred to as “sendust”) or NiFeMo (commonly referred to as “supermalloy”)). In some embodiments, the ferromagnetic material comprises crystalline ferromagnetic material (e.g., soft magnetic alloys of FeSiAl, NiFe, NiFeMo, FeCo, or FeCoNi). In some embodiments, the ferromagnetic material comprises amorphous ferromagnetic metal (e.g., soft magnetic alloys of FeCoB, or TLTE, where TL is at least one of Fe, Co, or Ni, and TE is at least one of Zr, Ta, Nb, or Hf).

The use of ferromagnetic metal material layers or metal based granular material layers provides high magnetic saturation induction. Variation in the aspect ratio of the two-dimensional flake can be used to control for higher permeability, or higher ferromagnetic resonance frequency (i.e., less loss coming from resonance). A higher ratio of flake diameter to flake thickness tends to increase permeability. Further, the spaces between flakes form natural air gaps leading to slow saturation.

In some embodiments, the ferromagnetic material layers each have a thickness up to 1000 (in some embodiments, up to 750, 500, 250, 200, or even up to 150) nm. It is generally desirable for the thickness of a ferromagnetic material layer to be less than ¼ (in some embodiments, less than ¼) of the skin depth of the layer, wherein the skin depth is calculated from the formula

505*sqrt(ρ/μf),

where ρ is the resistivity (Ω-m) of the ferromagnetic layer, μ is the relative permeability of the layer itself, and f is frequency (Hz) of the electrical excitation interacting with the inductor.

In some embodiments, at least 50 (in some embodiments, at least 55, 60, 65, 70, 75, 80, 85, 90, 95, 96, 97, 98, 99, 99.5, or even 100) percent by number of each ferromagnetic material layer comprises at least 50 (in some embodiments, at least 55, 60, 65, 70, 75, 80, 85, 90, 95, 96, 97, 98, 99, 99.5, or even 100) percent by volume ferromagnetic material, based on the total volume of the respective ferromagnetic material layer.

In some embodiments, the ferromagnetic material is in the form of granules dispersed in a second electrically insulating material (see, e.g., FIG. 2). In some embodiments, the granules have particle sizes in a range from 1 nm to 30 nm (in some embodiments, 2 nm to 15 nm).

The ferromagnetic material, in the form of granules dispersed in a second electrically insulating material, can be provided, for example, by co-sputtering from two cathodes, one has a ferromagnetic metal target, and the other has an insulator target.

In some embodiments, the electrically insulating material comprising the insulating layer and the electrically insulating material, in which the granules are dispersed, are the same material (i.e., the same composition). In some embodiments, the electrically insulating material comprising the insulating layer and the electrically insulating material, in which the granules are dispersed, are different materials (i.e., different compositions).

In some embodiments, the electrically insulating layers each have a thickness of at least 5 (in some embodiments, up to 10, 15, 20, 25, 30, 35, 40, 50, 75, 100, 125, or even up to 150; in some embodiments, in a range from 5 to 150, 50 to 100, or even 10 to 150) nm. Typically, it is desirable for an electrically insulating layer to be as thin as possible while still ensuring adequate magnetic and electrical isolation of the ferromagnetic metal layers.

In some embodiments, the multilayered flakes each have a thickness up to 10 (in some embodiments, up to 9, 8, 7, 6, 5, 4, 3, 2, or even up to 1) micrometers.

In some embodiments, the multilayered flakes are present in an amount of at least 10 (in some embodiments, at least 20, 30, 40, 50, 60, or even 70; in some embodiments, in the range from 30 to 60) percent by volume of the high frequency power inductor material.

In some embodiments, the high temperature binder is at least one of a diglycidyl ether of at least one of polyhydric phenols, acrylates, benzoxazines, cyanate ester, polyimide, polyamide, polyester, polyurethanes, or epoxy resins (e.g., epoxy novolac resins).

In some embodiments, the high frequency power inductor materials described herein have a relative permeability of at least 20 (in some embodiments, at least 30, 40, 50, 75, 100, 150, 200, or even up to 250).

In some embodiments, the high frequency power inductor materials described herein have a saturation magnetic induction, Bₛ, of at least 0.2 (in some embodiments, at least 0.3, 0.4, 0.5, 0.6, 0.7, 0.8, 0.9, or even at least 1) T.

In some embodiments, the high frequency power inductor materials described herein have a magnetic resonance frequency in a range from 50 to 1500 (in some embodiments, 800 to 1400, or even 1000 to 5000) megahertz.

In some embodiments, the high frequency power inductor materials described herein have a magnetic coercivity, H_{c}, not greater than 10 (in some embodiments, not greater than 5) Oe.

In some embodiments, the flakes have an aspect ratio of up to 100:1 (in some embodiments, at least 75:1, 50:1, 25:1, or even up to 10:1; in some embodiments, in a range from 10:1 to 100:1).

Exemplary high frequency power inductor materials described herein are useful, for example, as a power inductor in Point of Load (POL) converters, low profile inductors for inductive-capacitive (LC) filters (e.g., for global system mobile communication (GSM) pulse noise suppression in cellular phone speakers), or other applications wherein compact, inductive elements are required on a circuit board.

### Exemplary Embodiments

1A. A high frequency (i.e., 5 MHz to 150 MHz) power inductor material having first and second opposed major surfaces, comprising:

a high temperature binder; and

a plurality of multilayered flakes dispersed in the high temperature binder, the multilayered flakes comprising at least two (in some embodiments, at least 5, 10, 15, 20, 25, 30, 35, 40, 45, 50, 60, 70, 75, 80, 85, 90, 95, or even at least 100; in some embodiments, in a range from 2 to 100, 5 to 50, or even 20 to 40) layer pairs, wherein each layer pair comprises a ferromagnetic layer and a dielectric electrical isolation layer so that the ferromagnetic layers are electrically isolated from each other by dielectric layers, and wherein the multilayered flakes are substantially aligned parallel to the first and second major surfaces such that they do not provide an electrically continuous path over a range of greater than 0.5 mm.
2A. The high frequency power inductor material of Exemplary Embodiment 1A, wherein the multilayered flakes each have a thickness up to 10 (in some embodiments, up to 9, 8, 7, 6, 5, 4, 3, 2, or even up to 1) micrometers.
3A. The high frequency power inductor material of any preceding A Exemplary Embodiment, wherein at least 50 (in some embodiments, at least 55, 60, 65, 70, 75, 80, 85, 90, 95, 96, 97, 98, 99, 99.5, or even 100) percent by number of each ferromagnetic material layer comprises at least 50 (in some embodiments, at least 55, 60, 65, 70, 75, 80, 85, 90, 95, 96, 97, 98, 99, 99.5, or even 100) percent by volume ferromagnetic material, based on the total volume of the respective ferromagnetic material layer.

4A. The high frequency power inductor material of Exemplary Embodiment 3A, wherein the ferromagnetic material is in the form of granules dispersed in an electrically insulating material.
5A. The high frequency power inductor material of Exemplary Embodiment 4A, wherein the granules have particle sizes in a range from 1 nm to 30 nm (in some embodiments, 2 nm to 15 nm).
6A. The high frequency power inductor material of either Exemplary Embodiment 4A or 5A, wherein the electrically insulating material comprises, on a theoretical basis, at least one of Al₂O₃, HfO₂, SiO, SiO₂, Y₂O₃, ZnO, ZrO₂, Si₃N₄, B₂O₃, or MgF₂.
7A. The high frequency power inductor material of either Exemplary Embodiment 4A or 5A, wherein the electrically insulating material is at least one of Al₂O₃, HfO₂, SiO, SiO₂, Y₂O₃, ZnO, ZrO₂, Si₃N₄, B₂O₃, or MgF₂.

8A. The high frequency power inductor material of Exemplary Embodiment 7A, wherein the ferromagnetic material comprises at least one of Co, Fe, or Ni.

9A. The high frequency power inductor material of Exemplary Embodiment 7A, wherein the ferromagnetic material comprises at least two of Co, Fe, or Ni.

10A. The high frequency power inductor material of either Exemplary Embodiment 8A or 9A, wherein the ferromagnetic material further comprises at least one of Mo, Cr, Cu, V, Si, or Al.

11A. The high frequency power inductor material of Exemplary Embodiment 7A, wherein the ferromagnetic material is a soft magnetic alloy of at least one of FeCo, NiFe, or FeCoNi.

12A. The high frequency power inductor material of any preceding A Exemplary Embodiment, wherein the electrically insulating layer comprises, on a theoretical basis, at least one of Al₂O₃, HfO₂, SiO, SiO₂, Y₂O₃, ZnO, ZrO₂, Si₃N₄, B₂O₃, or MgF₂.

13A. The high frequency power inductor material of any preceding A Exemplary Embodiment, wherein the ferromagnetic material layers each have a thickness up to 1000 (in some embodiments, up to 750, 500, 250, 200, or even up to 150) nm.
14A. The high frequency power inductor material of any preceding A Exemplary Embodiment, wherein the electrically insolating layers each have a thickness of at least 5 (in some embodiments, up to 10, 15, 20, 25, 30, 35, 40, 50, 75, 100, 125, or even up to 150; in some embodiments, in a range from 5 to 150, or even 10 to 150) nm.

15A. The high frequency power inductor material of any preceding A Exemplary Embodiment, wherein the multilayered flakes are present in an amount of at least 10 (in some embodiments, at least 20, 30, 40, 50, 60, or even 70; in some embodiments, in the range from 30 to 60) percent by volume of the high frequency power inductor material.

16A. The high frequency power inductor material of any preceding A Exemplary Embodiment, wherein the ferromagnetic material comprises ferromagnetic metal.

17A. The high frequency power inductor material of any preceding A Exemplary Embodiment, wherein the ferromagnetic material comprises crystalline ferromagnetic material.

18A. The high frequency power inductor material of Exemplary Embodiment 17A, wherein the ferromagnetic material is a NiFe soft magnetic alloy.

19A. The high frequency power inductor material of Exemplary Embodiment 17A, wherein the ferromagnetic material is a soft magnetic alloy of at least one of FeCo, NiFe, or FeCoNi.

20A. The high frequency power inductor material of any preceding A Exemplary Embodiment, wherein the ferromagnetic material comprises amorphous ferromagnetic metal.

21A. The high frequency power inductor material of Exemplary Embodiment 20A, wherein the ferromagnetic material is a soft magnetic alloy of at least one of FeCoB or TLTE, where TL is at least one of Fe, Co, or Ni, and TE is at least one of Zr, Ta, Nb, or Hf.

22A. The high frequency power inductor material of any preceding A Exemplary Embodiment, wherein each electrically insulating layer comprises at least one of a nitride, fluoride, or oxide.
23A. The high frequency power inductor material of any preceding A Exemplary Embodiment, wherein the high temperature binder is a diglycidyl ether of at least one of polyhydric phenols, acrylates, benzoxazines, cyanate ester, polyimide, polyamide, polyester, polyurethanes, or epoxy resins (e.g., epoxy novolac resins).

24A. The high frequency power inductor material of any preceding A Exemplary Embodiment having a relative permeability of at least 20 (in some embodiments, at least 30, 40, 50, 75, 100, 150, 200, or even up to 250).

25A. The high frequency power inductor material of any preceding A Exemplary Embodiment having a saturation magnetic induction, Bₛ, of at least 0.2 (in some embodiments, at least 0.3, 0.4, 0.5, 0.6, 0.7, 0.8, 0.9, or even at least 1) T.

26A. The high frequency power inductor material of any preceding A Exemplary Embodiment having a magnetic resonance frequency in a range from 50 to 1500 (in some embodiments, 800 to 1400, or even 1000 to 5000) megahertz.

27A. The high frequency power inductor material of any preceding A Exemplary Embodiment having a magnetic coercivity, H_{c}, not greater than 10 (in some embodiments, not greater than 5) Oe.

28A. The high frequency power inductor material of any preceding A Exemplary Embodiment, wherein the flakes have an aspect ratio of up to 100:1 (in some embodiments, at least 75:1, 50:1, 25:1, or even up to 10:1; in some embodiments, in a range from 10:1 to 100:1).

29A. The high frequency power inductor material of any preceding A Exemplary Embodiment having a skin depth, wherein the magnetic layer thickness is less than (in some embodiments, not greater than ½, (in some embodiments, less than ¼) of the skin depth.

Advantages and embodiments of this invention are further illustrated by the following examples, but the particular materials and amounts thereof recited in these examples, as well as other conditions and details, should not be construed to unduly limit this invention. All parts and percentages are by weight unless otherwise indicated.

### EXAMPLES

### Core Loss Measurement Test Method

The core loss was measured as described in D. Hou et. al., “New high-frequency core loss measurement method with partial cancellation concept”, pp. 2987-2994, IEEE Transactions on Power Electronics, Vol. 32, No. 4, (2017), the disclosure of which is incorporated herein by reference.

### Permeability Spectrum Measurement Test Method

Permeability spectrum from 1 MHz to 100 MHz is measured using an impedance analyzer (obtained under the trade designation “KEYSIGHT E4990A” Keysight Technologies Inc., Santa Rosa, Calif.) and a terminal adapter (obtained under the trade designation “42942A” from Keysight Technologies Inc.).

### Example 1

### (EX-1)

Permeable multi-layered NiFe/insulator particulate material consisting of multiple sub-skin-depth magnetic layers alternated with dielectric spacer layers (FFDM) particles (permeable multi-layered NiFe/insulator particulate material of multiple sub-skin-depth magnetic layers alternated with dielectric spacer layers) (obtained under the trade designation “3M FLUX FIELD DIRECTIONAL MATERIALS PARTICLE EM05EC” from 3M Company, St. Paul, Minn.) were in the form of flakes with total flake thickness of about 6 micrometers, and a lateral size less than 500 micrometers. Four grams of the selected particles were mixed with 2.5 grams of polyimide resin (PIR) (obtained under the trade designation “UN1866 CP1” from NeXolve Corporation, Huntsville, Ala.) and 1 milliliter of diethylene glycol dimethyl ether (obtained from Alfa Aesar, Lancashire, United Kingdom) in a mixing jar (obtained under the trade designation “FLACTEK 501 222PT-J Max 60” from FlackTek, Landrum, S.C.). After mixing with a mixer (obtained under the trade designation “DAC 600 FVZ SPEEDMIXER” from FlackTek), the slurry was coated onto a polyethylene terephthalate (PET) substrate (obtained under the trade designation “MELINEX ST504” from Tekra, New Berlin, Wis.) using a film applicator (obtained under the trade designation “MICROM II FILM APPLICATOR” from Gardco, Pompano Beach, Fla.). The coated film was 180 micrometers thick after drying at 90° C. for 1 hour. The composite sheet was then peeled off the substrate backing.

Subsequently, the composite sheet was cut and 4 pieces were stacked on top of one another for pressing. A heated press (obtained as Model 20-122TM2WCB from Wabash MPI, Wabash, Ind.) was used to densify the composite at 5 tons on a 4-inch (10-cm) diameter ram at 275° C. for 5 minutes, and then immediately cooled to room temperature under the same pressure for 3 minutes. A set of steel shims were used during pressing for setting composite thickness.

The static magnetic property of the EX-1 multilayer flake composite was tested with a vibrating sample magnetometer (obtained under the trade designation “VSM”; Model 7307 from Lake Shore Cryotronics, Westerville, Ohio). The coercivity of the EX-1 composite was found to be about 1.6 Oersted (Oe). The volume ratio between flakes and the composite was about 34%, and thickness of the sample was 0.53 millimeter.

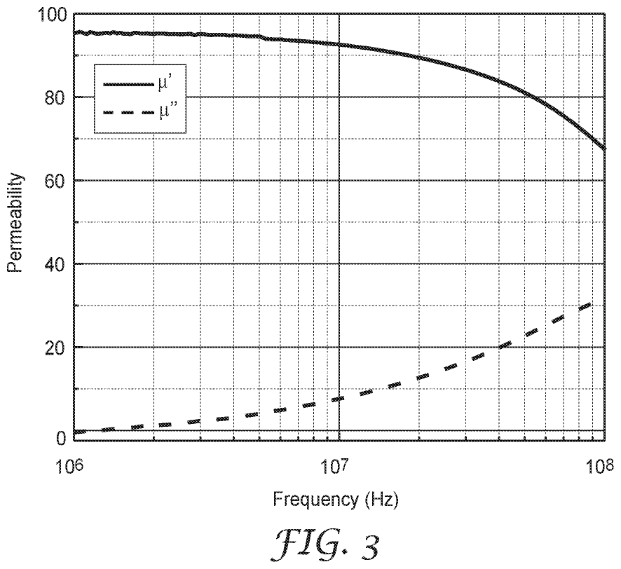

The Permeability Spectrum Measurement Test Method was used to measure the permeability spectrum of the EX-1 composite. At 1 MHz, the real part of the permeability (μ′) was measured to be 96 and decreased slightly to 90 at 20 MHz, while the imaginary part of the permeability (μ″) remained less than 12 at 20 MHz (see FIG. 3). The magnetic loss tangent is defined as the ratio between the imaginary part and the real part of permeability. For EX-1, the loss tangent remained lower than 0.14 up to 20 MHz.

The Core Loss Measurement Test Method was used to measure the core loss of the composite EX-1. At 20 MHz, the EX-1 composite had a core loss density of 8400 kilowatt per meter cubed (kW/m³) with a maximum magnetic induction of 10 millitesla (mT) and a core loss density of 20500 kW/m³ with maximum magnetic induction of 15 mT.

### Example 2

### (EX-2)

FFDM particles (prepared as described in EX-1) were sieved to down select a lateral size larger than 120 micrometers. Three grams of the selected particles were mixed with 0.5 gram of high temperature epoxy (obtained under the trade designation “DURALCO 4460” (316° C. (600° F.) low viscosity epoxy) from Cotronics, Brooklyn, N.Y.) in a mixing jar (“FLACTEK 501 222PT-J MAX 60”). After mixing with a spatula, the slurry was placed between two conventional polyethylene terephthalate (PET) sheets coated with a silicone release layer. A rubber roller was used to spread the slurry between the two PET sheets. The coated film was cured at 120° C. (250° F.) for 80 minutes. The composite sheet was then peeled off the substrate backing. The thickness of the composite sheet was about 0.5 mm.

Subsequently, the composite sheet was cut and 2 pieces were stacked on top of one another for pressing. The heated press (Model 20-122TM2WCB) was used to densify the composite at 4 tons on a 4-inch (10-cm) diameter ram at 120° C. for 1 hour, and then immediately cooled to room temperature under the same pressure for 3 minutes. A set of steel shims were used during pressing for setting composite thickness. The final sample thickness was 0.98 mm.

The static magnetic property of the EX-2 multilayer flake composite was tested with a vibrating sample magnetometer (“VSM”; Model 7307). The coercivity of the EX-2 composite was found to be about 1.4 Oersted (Oe). The volume ratio between flakes and the composite was about 32%.

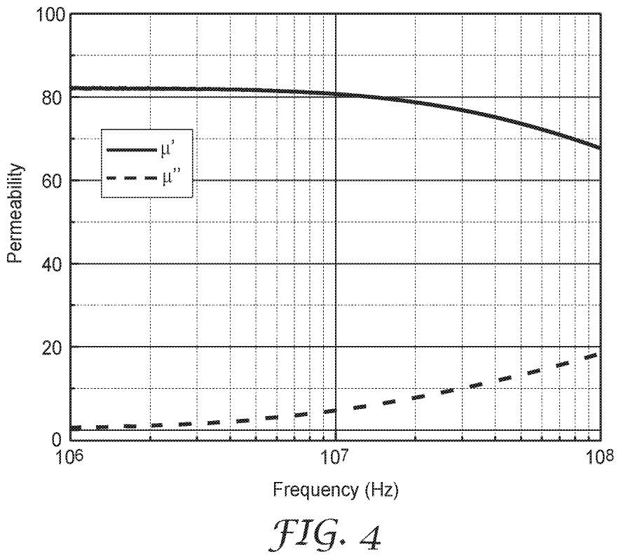

The Permeability Spectrum Measurement Test Method was used to measure the permeability spectrum of the EX-2 composite. At 1 MHz, the real part of the permeability (μ′) was measured to be 81 and decreased slightly to 79 at 20 MHz, while the imaginary part of the permeability (μ″) remained less than 8 at 20 MHz (see FIG. 4). In this sample, the loss tangent remained lower than 0.1 up to 20 MHz.

The Core Loss Measurement Test Method was used to measure the core loss of the EX-2 composite. At 20 MHz, the EX-2 composite had a core loss density of 7400 kW/m3 with a maximum magnetic induction of 10 mT and a core loss density of 18900 kW/m3 with a maximum magnetic induction of 15 mT.

Foreseeable modifications and alterations of this disclosure will be apparent to those skilled in the art without departing from the scope and spirit of this invention. This invention should not be restricted to the embodiments that are set forth in this application for illustrative purposes.

1. A high frequency power inductor material having first and second opposed major surfaces, comprising:
a thermosetting binder; and
a plurality of multilayered flakes dispersed in the high temperature binder, the multilayered flakes comprising at least two layer pairs, wherein each layer pair comprises a ferromagnetic layer and a dielectric electrical isolation layer so that the ferromagnetic layers are electrically isolated from each other by dielectric layers, and wherein the multilayered flakes are substantially aligned parallel to the first and second major surfaces such that they do not provide an electrically continuous path over a range of greater than 0.5 millimeters.

2. The high frequency power inductor material of claim 1, wherein the multilayered flakes each have a thickness up to 10 micrometers.

3. The high frequency power inductor material of claim 1, wherein at least 50 percent by number of each ferromagnetic material layer comprises at least 50 percent by volume ferromagnetic material, based on the total volume of the respective ferromagnetic material layer.

4. The high frequency power inductor material of claim 3, wherein the ferromagnetic material is in the form of granules dispersed in an electrically insulating material.

5. The high frequency power inductor material of claim 4, wherein the granules have particle sizes in a range from 1 nanometer to 30 nanometers.

6. The high frequency power inductor material of claim 4, wherein the electrically insulating material comprises, on a theoretical basis, at least one of Al₂O₃, HfO₂, SiO, SiO₂, Y₂O₃, ZnO, ZrO₂, Si₃N₄, B₂O₃, or MgF₂.

7. The high frequency power inductor material of claim 4, wherein the electrically insulating material is at least one of Al₂O₃, HfO₂, SiO, SiO₂, Y₂O₃, ZnO, ZrO₂, Si₃N₄, B₂O₃, or MgF₂.

8. The high frequency power inductor material of claim 7, wherein the ferromagnetic material is at least one of Co, Fe, or Ni.

9. The high frequency power inductor material of claim 1, wherein the electrically insulating layer comprises, on a theoretical basis, at least one of Al₂O₃, HfO₂, SiO, SiO₂, Y₂O₃, ZnO, ZrO₂, Si₃N₄, B₂O₃, or MgF₂.

10. The high frequency power inductor material of claim 1, wherein the ferromagnetic material layers each have a thickness up to 1000 nanometers.

11. The high frequency power inductor material of claim 1, wherein the electrically insolating layers each have a thickness of at least 5 nanometers.

12. The high frequency power inductor material of claim 1, wherein the multilayered flakes are present in an amount of at least 10 percent by volume of the high frequency power inductor material.

13. The high frequency power inductor material of claim 1, wherein the ferromagnetic material comprises ferromagnetic metal.

14. The high frequency power inductor material of claim 1, wherein the ferromagnetic material comprises crystalline ferromagnetic material.

15. The high frequency power inductor material of claim 14, wherein the ferromagnetic material is a NiFe soft magnetic alloy.

16. The high frequency power inductor material of claim 14, wherein the ferromagnetic material is at least one of NiFe, FeCoNi, or FeCo soft magnetic alloy.

17. The high frequency power inductor material of claim 1, wherein the ferromagnetic material comprises amorphous ferromagnetic metal.

18. The high frequency power inductor material of claim 17, wherein the ferromagnetic material is a soft magnetic alloy of at least one of FeCoB or TLTE, where TL is at least one of Fe, Co, or Ni, and TE is at least one of Zr, Ta, Nb, or Hf.

19. The high frequency power inductor material of claim 1, wherein each electrically insulating layer comprises at least one of a nitride, fluoride, or oxide.

20. The high frequency power inductor material of claim 1, wherein the high temperature binder is a diglycidyl ether of at least one of polyhydric phenols, acrylates, benzoxazines, cyanate ester, polyimide, polyamide, polyester, polyurethanes, or epoxy resins.

21-26. (canceled)
